(19) United States
(12) Patent Application Publication
(10) Pub. No.: US 2009/0053391 A1
(43) Pub. Date: Feb. 26, 2009

(54) Method Of Coating A Drug-Releasing Layer Onto A Substrate

(76) Inventors: Florian N. Ludwig, Ebikon (CH); Stephen D. Pacetti, San Jose, CA (US)

Correspondence Address: SQUIRE, SANDERS & DEMPSEY LLP, 1 MARITIME PLAZA, SUITE 300, SAN FRANCISCO, CA, 94111, US

(21) Appl. No.: 12/239,328

(22) Filed: Sep. 26, 2008

Related U.S. Application Data
(63) Continuation-in-part of application No. 11/295,956, filed on Dec. 6, 2005.

(51) Int. Cl. B05D 3/00

(52) U.S. Cl. 427/2.14

(57) ABSTRACT

This invention relates to processes for coating a substrate with a drug-containing layer in which the microstructure of the resulting dry drug reservoir layer is not a function of solvent removal.

### RELATED APPLICATIONS

This application is a continuation-in-part of application Ser. No. 11/295,956 filed on Dec. 6, 2005, which is incorporated by reference as if fully set forth, including any drawings, herein.

### FIELD

This invention relates to the fields of chemistry, polymer chemistry, materials science, and medical devices.

### BACKGROUND

The discussion that follows is intended solely as background information to assist in the understanding of the invention herein; nothing in this section is intended to be, nor is it to be construed as, prior art to this invention.

Until the mid-1980s, the accepted treatment for atherosclerosis, i.e., narrowing of the coronary artery(ies) was coronary by-pass surgery. While effective and evolved to a relatively high degree of safety for such an invasive procedure, by-pass surgery still involves serious potential complications, and in the best of cases, an extended recovery period.

With the advent of percutaneous transluminal coronary angioplasty (PTCA) in 1977, the scene changed dramatically. Using catheter techniques originally developed for heart exploration, inflatable balloons were employed to re-open occluded regions in arteries. The procedure was relatively non-invasive, took a very short time compared to by-pass surgery and the recovery time was minimal. However, PTCA brought with it another problem, elastic recoil of the stretched arterial wall which could undo much of what was accomplished and, in addition, PTCA failed to satisfactorily ameliorate another problem, restenosis, the re-clogging of the treated artery.

The next improvement, advanced in the mid-1980s, was use of a stent to hold the vessel walls open after PTCA. This for all intents and purposes put an end to elastic recoil but did not entirely resolve the issue of restenosis. That is, prior to the introduction of stents, restenosis occurred in 30-50% of patients undergoing PTCA. Stenting reduced this to about 15-30%, much improved but still more than desirable.

In 2003, the drug-eluting stent (DES) was introduced. The drugs initially employed with the DES were cytostatic compounds, compounds that curtailed the proliferation of cells that contributed to restenosis. As a result, restenosis was reduced to about 5-7%, a relatively acceptable figure. Today, the DES is the default industry standard for the treatment of atherosclerosis and is rapidly gaining favor for treatment of stenoses of blood vessels other than coronary arteries such as peripheral angioplasty of the femoral artery.

One of the key issues with DESs is control of the rate of release of the drug from the coating. If the bulk of the drug is released soon after implantation, known in the art as “burst release,” the intent of providing prolonged delivery is defeated. Furthermore, burst release may result in local drug concentrations that are toxic. On the other hand, drug delivery release rates which are too slow may not provide a sufficiently high local concentration to have the intended therapeutic effect.

What is needed is a method of coating DESs and other implantable drug-carrying constructs with drug-containing layers having precise and predictable drug releasing characteristics. What is also needed are coating methods which do not use organic solvents that have the effect of degrading or altering some therapeutic agents. The present invention provides such a coating method.

### SUMMARY

The current invention is directed to methods of coating substrates.

Thus, in one aspect, the present invention relates to method of disposing a coating over a substrate. The method includes the acts of: dissolving or dispersing a polymer in a solvent; dissolving or dispersing a drug in the solvent to form a coating solution; disposing the coating solution over at least a portion of a surface of a substrate; precipitating both the polymer and the drug onto the surface of the substrate; and, after precipitation, substantially removing the solvent.

In an aspect of this invention, the substrate is selected from the group consisting of an implantable medical device and a particle.

In an aspect of this invention, the implantable medical device is a stent.

In an aspect of this invention, the polymer comprises a biopolymer.

In an aspect of this invention, the polymer comprises a hydrophobic polymer.

In an aspect of this invention, the particle is selected from the group consisting of a micelle, liposome, a nanoparticle and a microparticle.

In an aspect of this invention, the polymer comprises a binding moiety.

In an aspect of this invention, the binding moiety is selected from the group consisting of a cyclodextrin, a crown ether, a chelating agent, a ligand, a cryptand, an antibody and any combination thereof.

In an aspect of this invention, precipitation is initiated by a precipitation trigger.

In an aspect of this invention, the precipitation trigger is selected from the group consisting of a change in pH, a change in temperature, a change in pressure, addition of specific ions, a change in dielectric potential, a change in ionic strength, a change in light wavelength and/or intensity, addition of a non-solvent, a change in electric potential, a change in magnetic field strength, and combinations thereof.

In an aspect of this invention, the precipitation trigger comprises a change in temperature of the substrate.

In an aspect of this invention, the solvent is a supercritical fluid.

Thus, another aspect of this invention is a method of disposing a coating over a substrate. The method includes the acts of: dissolving or dispersing a polycation in a first solvent; dissolving or dispersing a first drug in the first solvent to create a polycation coating solution; disposing the polycation coating solution over at least a portion of a surface of a substrate wherein the substrate is negatively charged; substantially removing the solvent; dissolving or dispersing a polyanion in a second solvent, which may be the same as or different from the first solvent; dissolving or dispersing a second drug, which may be the same as or different from the first drug, in the second solvent to form a polyanion coating solution; disposing the polyanion coating solution over at least the portion of the surface of the substrate over which the polycation coating solution has been disposed; substantially removing the solvent; alternating disposing of the polycation coating solution, substantially removing the solvent, disposing the polyanion coating solution and substantially removing the solvent, until a desired drug reservoir thickness is achieved.

Thus, another aspect of this invention is a method of disposing a coating over a substrate including the acts of: dissolving or dispersing a polyanion in a first solvent; dissolving or dispersing a first drug in the first solvent to form a polyanion coating solution; disposing the polyanion coating solution to at least a portion of a surface of a substrate wherein the substrate is positively charged; substantially removing the solvent; dissolving or dispersing a polycation in a second solvent; dissolving or dispersing a second drug, which may be the same as or different from the first drug, in the second solvent to create a polycation coating solution; disposing the polycation coating solution over the portion of the surface of the substrate over which the polyanion coating solution has been disposed; substantially removing the solvent; alternating disposing the polyanion coating solution, substantially removing the solvent, disposing the polycation solution and substantially removing the solvent until a desired coating thickness is achieved.

In an aspect of this invention, disposing the polyanion and polycation solutions comprises spraying the solutions onto the substrate.

In an aspect of this invention, disposing the polyanion and polycation solutions comprises dipping the substrate into the solutions.

### DETAILED DESCRIPTION

### Discussion

Use of the singular herein includes the plural and vice versa unless expressly stated to be otherwise. That is, “a” and “the” refer to one or more of whatever the word modifies. For example, “a drug” may refer to one drug, two drugs, etc. Likewise, “the layer” may refer to one, two or more layers and “the polymer” may mean one polymer or a plurality of polymers. By the same token, words such as, without limitation, “layers” and “polymers” refers to one layer or polymer as well as to a plurality of layers or polymers unless, again, it is expressly stated or obvious from the context that such is not intended.

As used herein, unless specified otherwise, any words of approximation such as, without limitation, “about,” “essentially,” “substantially” and the like mean that the element so modified need not be exactly what is described but can vary from the description by as much as ±10% without exceeding the scope of this invention.

As used herein, an “implantable medical device” refers to any type of appliance that is totally or partly introduced, surgically or medically, into a patient's body or by medical intervention into a natural orifice, and which is intended to remain there after the procedure. The duration of implantation may be essentially permanent, i.e., intended to remain in place for the remaining lifespan of the patient; until the device biodegrades; or until it is physically removed. Examples of implantable medical devices include, without limitation, implantable cardiac pacemakers and defibrillators; leads and electrodes for the preceding; implantable organ stimulators such as nerve, bladder, sphincter and diaphragm stimulators; cochlear implants; prostheses, vascular grafts, self-expandable stents, balloon-expandable stents, stent-grafts, grafts, artificial heart valves, cerebrospinal fluid shunts, patent foramen ovale closure devices, and intrauterine devices. While the preceding devices all have a primary function and, as a secondary function may be coated with a drug containing layer of this invention, an implantable medical device specifically designed and intended solely for the localized delivery of a therapeutic agent is also within the scope of this invention.

As used herein, “device body” refers to an implantable medical device in a fully formed utilitarian state with an outer surface to which no layer of material different from that of which the device is manufactured has been applied. By “outer surface” is meant any surface however spatially oriented that is in contact with bodily tissue or fluids. A common example of a “device body” is a BMS, a bare metal stent, which, as the name implies, is a fully-formed usable stent that has not been coated with a layer of any material different from the metal of which it is made on any surface that is in contact with bodily tissue or fluids. Of course, device body refers not only to BMSs but to any uncoated device regardless of what material it is constructed. In fact, implantable medical devices can be made of virtually any biocompatible material and the material from which the device is manufactured is not a limitation on the use of the coating methods of the present invention.

As used herein, a “polymer” refers to a molecule comprised of repeating “constitutional units,” wherein the constitutional units derive from the reaction of monomers. As a non-limiting example, ethylene (CH₂═CH₂) is a monomer that can be polymerized to form polyethylene, CH₃CH₂(CH₂CH₂)ₙCH₂CH₃, wherein the constitutional unit is —CH₂CH₂—, ethylene having lost the double bond as the result of the polymerization reaction. A polymer of this invention may be derived from the polymerization of several different monomers and therefore may comprise several different constitutional units. Such polymers are referred to as “copolymers.” Those skilled in the art, given a particular polymer, will readily recognize the constitutional units of that polymer and will equally readily recognize the structure of the monomer from which the constitutional units derive.

Polymers of this invention may be regular alternating polymers, random alternating polymers, regular block polymers, random block polymers or purely random polymers unless expressly noted otherwise. Assuming for the sake of illustration that a particular polymer is comprised of three constitutional units, a regular alternating polymer has the general structure: . . . x-y-z-x-y-z-x-y-z- . . . . A random alternating polymer has the general structure: . . . x-y-x-z-x-y-z-y-z-x-y- . . . , it being understood that the exact juxtaposition of the various constitution units may vary. A regular block polymer has the general structure: . . . x-x-x-y-y-y-z-z-z-x-x-x . . . , while a random block polymer has the general structure: . . . x-x-x-z-z-x-x-y-y-y-y-z-z-z-x-x-z-z-z- . . . . Similarly to regular and alternating polymers, the exact arrangement of the blocks, the number of constitutional units in each block and the number of blocks in a block copolymer of this invention are not in any manner limited by the preceding illustrative generic structures.

As used herein, “biopolymer” refers to a naturally occurring polymer while a synthetic polymer refers to one that is created wholly in the laboratory and a semi-synthetic polymer refers to a naturally-occurring polymer than has been chemically modified in the laboratory. Examples of naturally-occurring polymers include, without limitation, collagen, chitosan, alginate, fibrin, fibrinogen, cellulosics, starches, dextran, dextrin, hyaluronic acid, heparin, glycosaminoglycans, polysaccharides and elastin. Examples of synthetic polymers include, without limitation, polyalkylenes, poly(ester amide)s, polyurethanes and polyureas. Examples of semi-synthetic polymers include, without limitation, methyl cellulose, ethyl cellulose, carboxymethyl cellulose, hydroxypropyl cellulose and the like.

As used herein, a “crosslink” refers to a joining of two separate chains of a polymer by reaction of non-terminal functional groups on the polymer with a multifunctional cross-linking agent, that is, a compound having two or more functional groups that are capable of reacting with functional groups appended to the polymer backbone.

As used herein, a “polyion” refers to a polymer molecule containing multiple anion, cations or a combination thereof (zwitterions). For the purposes of this invention, the polyionic polymer has a molecular weight of at least about 1000 Da. Depending upon the type of polymer, the distribution of ionic species may be regular with all, or substantially all, every other, every third, etc., constitutional unit containing an ionic group or the distribution may be random. If the polymer is a block copolymer, one, more than one, or all of the blocks may be polyionic.

As used herein, “biocompatible” refers to a polymer or other material that both in its intact, that is, as synthesized, state and in its decomposed state, i.e., its degradation products, is not, or at least is minimally, toxic to living tissue; does not, or at least minimally and reparably, injure(s) living tissue; and/or does not, or at least minimally and/or controllably, cause(s) an immunological reaction in living tissue.

As used herein, a material that is described as being “disposed over” an indicated substrate refers to a coating or layer of the material deposited directly or indirectly over at least a portion of the surface of the substrate. Direct depositing means that the coating is applied directly to the surface of the substrate. Indirect depositing means that the coating is applied to an intervening layer that has been deposited directly or indirectly over the substrate. The terms “coating”, “layer”, and “coating layer” are used interchangeably herein.

As used herein, “microstructure” refers to the structure of the components or phases of a coating layer that may be seen using an imaging technique such as scanning electron microscopy, atomic force microscopy, or optical microscopy and includes the distribution of the domains of the different chemical components, the crystal structure of the domains, orientation of the domains and components thereof, and any other microscopic characteristic that contributes to the desired physical properties of the layer as set forth herein.

As used herein, a “primer layer” refers to a coating consisting of a polymer or blend of polymers, or other materials that exhibit good adhesion characteristics with regard to the material of which the substrate is manufactured and whatever material is to be coated on the substrate. Thus, a primer layer serves as an adhesive intermediary layer between a substrate and materials to be carried by the substrate and is, therefore, applied directly to the substrate.

As used herein, “drug reservoir layer” refers to a layer that includes one or more drugs. The layer may comprise one or more drugs applied neat, with an excipient such as a binder, or as a component of a polymer matrix. A polymeric drug reservoir layer is designed such that, by one mechanism or another, e.g., without limitation, by elution or as the result of biodegradation of the polymer, the drug is released from the layer into the surrounding environment. For the purposes of this invention, a drug reservoir layer will refer to the finished layer resulting from the application of the methods herein, that is, after disposition of a single coating solution, which will create a single layer drug reservoir layer or after disposition of multiple coating solutions, which will create a multilayer drug reservoir layer.

As used herein, “solvent” refers to a fluid capable of dissolving or dispersing one or more substances to form a uniform solution or dispersion at a selected temperature and pressure. The solvent may comprise a single fluid or a mixture of different fluids.

As used herein, a “drug” refers to any substance that, when administered in a therapeutically effective amount to a patient suffering from a disease or condition, has a therapeutic beneficial effect on the health and well-being of the patient. A therapeutic beneficial effect on the health and well-being of a patient includes, but it not limited to: (1) curing the disease or condition; (2) slowing the progress of the disease or condition; (3) causing the disease or condition to retrogress; or, (4) alleviating one or more symptoms of the disease or condition.

As used herein, a drug also includes any substance that when administered to a patient, known or suspected of being particularly susceptible to a disease, in a prophylactically effective amount, has a prophylactic beneficial effect on the health and well-being of the patient. A prophylactic beneficial effect on the health and well-being of a patient includes, but is not limited to: (1) preventing or delaying on-set of the disease or condition in the first place; (2) maintaining a disease or condition at a retrogressed level once such level has been achieved by a therapeutically effective amount of a substance, which may be the same as or different from the substance used in a prophylactically effective amount; or (3) preventing or delaying recurrence of the disease or condition after a course of treatment with a therapeutically effective amount of a substance, which may be the same as or different from the substance used in a prophylactically effective amount, has concluded.

As used herein, “drug” also refers to pharmaceutically acceptable, pharmacologically active derivatives of those drugs specifically mentioned herein, including, but not limited to, salts, esters, amides, prodrugs, active metabolites, analogs, and the like.

As used herein, a “micelle” refers to a spherical colloidal core/shell nanoparticle spontaneously formed by many amphiphilic molecules in an aqueous medium when the Critical Micelle Concentration (CMC) is exceeded. The shell comprises a monolayer of the amphiphilic molecules. Amphiphilic molecules have two distinct components, differing in their affinity for a solute, most particularly water. The part of the molecule that has an affinity for non-polar solutes such as hydrocarbons is said to be hydrophobic. When amphiphilic molecules are placed in water, the hydrophilic moiety seeks to interact with the water while the hydrophobic moiety seeks to avoid the water. To accomplish this, the hydrophilic moiety remains in the water while the hydrophobic moiety is held above the surface of the water in the air or in a non-polar, non-miscible liquid floating on the water. The presence of this layer of molecules at the water's surface disrupts the cohesive energy at the surface and lowers surface tension. Amphiphilic molecules that have this effect are known as “surfactants.”

As used herein, a “liposome” is a core/shell construct in which the shell comprises a bilayer rather than a monolayer. Liposomes may be unilamellar, composed of a single bilayer, or they may be multilamellar, composed of two or more concentric bilayers. A phospholipid bilayer is formed from two layers of phospholipid molecules. Phospholipids are molecules that have two primary regions, a hydrophilic head region comprised of a phosphate of an organic molecule and one or more hydrophobic fatty acid tails. When phospholipids are placed in an aqueous environment, the hydrophilic heads come together in a linear configuration with their hydrophobic tails aligned essentially parallel to one another. A second line of molecules then aligns tail-to-tail with the first line as the hydrophobic tails attempt to avoid the aqueous environment. To achieve maximum avoidance of contact with the aqueous environment, i.e., at the edges of the bilayers, while at the same time minimizing the surface area to volume ratio and thereby achieve a minimal energy conformation, the two lines of phospholipids, know as a phospholipid bilayer or a lamella, converge into a sphere and in doing so entrap some of the aqueous medium, and whatever may be dissolved or suspended in it, in the core of the sphere.

As used herein, a “nanoparticle” refers to a particle with a maximum cross-sectional, i.e., through-particle rather than along the surface, dimension of from about 1 nm to about 100 nm.

As used herein, a “microparticle” refers to a particle with a maximum cross-sectional dimension of from about 101 nm to about 0.1 mm.

As used herein, a “chelator” is a compound which binds to one or more metal ions by a multiplicity of covalent, coordinate covalent, Van der Waals forces, hydrogen bonds or ionic bonds.

As used herein, a “cyclodextrin” is a cyclic sugar composed of 5 to 10 glucose residues that form a truncated cone that is capable of entrapping another molecule.

As used herein, a “crown ether” is a macrocyclic polyether which forms a ring structure with a hole in the center. Cations can complex with the oxygen atoms in the ring and thereby become entrapped in the center of the crown ether.

As used herein, a “ligand” is a molecule that binds to another molecule, and in general usage a ligand is said to bond to a receptor or binding site.

As used herein, an “antibody” is a specialized immune protein whose formation in the body is triggered by a foreign substance in the body and which can bind to such foreign substance.

As used herein, “supercritical” refers to a fluid that is above its critical point which is its critical temperature and the critical pressure. The critical point is reached when the molar volumes of liquid and gas become the same, so the distinction between the two separate phases vanishes. That is, below the critical point, gas and liquid phases can co-exist. Above the critical point, there is only one phase.

For the purposes of this invention, coating a substrate involves dissolving or dispersing a polymer and a drug, optionally with other additives, in a solvent to form a “coating solution,” and then disposing the coating solution over the substrate by procedures such as, without limitation, spraying or dipping, i.e., submerging a substrate in a coating solution and then withdrawing it from the solution, repeating as desired. These and other coating procedures are well-known in the art.

After the solution has been disposed over the stent, the solvent is substantially removed by evaporation. When the solvent has been removed, what is left is a solid layer comprised of the substances dissolved or dispersed in the coating solution. The process of removing the solvent can be accelerated by using elevated temperatures, and/or a flow of a dry gas or a supercritical fluid over the substrate. The layer that remains after the solvent has been substantially removed may include a small amount of residual solvent because removal of absolutely all of a solvent can be very difficult.

Generally, the microstructure of a coating is a function of the process of coating solution application and of solvent removal. In particular, the drying kinetics may impact the coating formed. The multiple consequences of solvent evaporation, more specifically rapid solvent evaporation, include sub-cooling the coating that may result in condensation of ambient water onto the coating, phase separation of the components in a non-equilibrium fashion and/or redistribution of drug in the coating as a result of the rapid diffusion of solvent giving rise to chromatographic movement of the drug.

In contrast to the above, the present invention relates to processes for coating a substrate that avoids, or at least minimizes, the impact of solvent removal on the coating microstructure, in particular on the distribution of a drug in the coating. Thus, a drug reservoir layer having a specific microstructure that will exhibit predetermined drug release characteristics can be achieved and will not be substantially impacted by the solvent removal process.

Thus, an aspect of the present invention involves a method whereby a coating solution is applied onto a substrate followed by application of a precipitation trigger which causes the solid materials in the solution to precipitate, only after which the solvent is removed. In this manner, the microstructure of the coating is established before solvent removal and the process of solvent removal has no substantial effect on that microstructure.

The microstructure of the coating may be determined using scanning electron microscopy, atomic force microscopy, optical microscopy, scanning micro-TA (micro-thermal analysis), confocal raman spectroscopy, differential scanning calorimetry and other physico-chemical techniques. These methods may be applicable to analyzing the surface of the coating, the coating in cross section, or the coating in bulk.

A coating solution herein may be applied to a substrate by any method known in the art including, without limitation, dipping the substrate into the solution or by spraying the solution onto the substrate.

There are no intrinsic limitations on the solvent which may be used in a coating solution of this invention. However, the methods used to apply the coating solution may impact the choice of solvent. If the application of the solution is by spraying, a solvent which evaporates very quickly may not allow for the application of the precipitation trigger before the solvent has substantially completely evaporated. If the substrate is dipped into the solution, then virtually any suitable solvent may be used as the precipitation trigger may be applied before the removal of the substrate from the solution. Thus, for spray application more suitable solvents include those which have a relatively high boiling point, such as without limitation, water or high boiling point organics such as, without limitation, dimethyl formamide, dimethyl acetamide, cyclohexanone, N-methylpyrrolidone, and dimethyl sulfoxide. More volatile solvents, such as, without limitation, acetone, 2-butanone, methylene chloride, chloroform, tetrahydrofuran, pentane, hexane, heptane, methanol, ethanol, isopropanol, methyl acetate ethyl acetate, propyl acetate, and isopropyl acetate may be used when application of the coating solution is by dipping the substrate in the coating solution.

The present invention also encompasses use of a supercritical fluid, such as, without limitation, supercritical carbon dioxide, to form the coating solution and/or to assist in solvent removal. Carbon dioxide in a liquid phase may be used.

Combinations of solvents and supercritical fluids are within the scope of this invention. For example, a supercritical fluid, such as, without limitation, supercritical carbon dioxide can be combined with another solvent, such as, again without limitation, ethyl acetate, acetone, water, methanol, ethanol, 2-propanol, 1-propanol, acetonitrile, tetrahydrofuran, dichloromethane, freons, and fluoroform.

Once a coating solution has been applied onto a substrate as by spraying or dipping, precipitation can be initiated by use of a precipitation trigger. Precipitation triggers include, without limitation, pH change, ionic strength change, addition of specific ions, temperature change, addition of a non-solvent for the coating materials, application of an electric field, application of a magnetic field, application of ultrasound, and light irradiation. It is understood of course that not all of the above triggers will be applicable to all coating materials. In particular, for application of an electric or magnetic field to have an effect, the coating materials in solution must be charged, or the substrate must contain magnetic particles or paramagnetic species. If the substrate includes particular chemical species such as electron-accepting substances, then formation of a charge-transfer complex may occur at the substrate surface.

A pH trigger generally requires the use of ionizable materials that under the proper circumstances form polycations and polyanions. For example, without limitation, polyacids, which form water-soluble polyanions at basic pHs, are protonated and therefore subject to precipitation at acidic pHs. Vice versa, polymers substituted with amino groups, which are protonated to form soluble polycations at acid pH, at basic pHs are neutral and insoluble. Examples of potentially polyanionic and polycationic polymers include those comprising acrylic acid, methacrylic acid, dimethylaminoethylmethacrylate (DMEAM), diethylaminoethylmethacrylate (DEAEM), acrylol-L-proline ethyl ester, methyacrylolglycine, or methacrylic acid-glycine, poly(methacrylic acid-co-nitrophenylacrylate), acrylic acid copolymers, methacrylic acid copolymers, and blends of polyacrylic acids. Poly(methyl methacrylate) (PMMA) and polyethylene glycol (PEG) graft copolymers and p(MMA-g-EG) hydrogels that swell at pHs above 6.6 but collapse when the pH is reduced to 6 or less.

Temperature triggers can be used with coating solution components that change solubility with a change in temperature such as, without limitation, polymers with a lower critical solution temperature (LCST). The polymer is soluble below its LCST, but precipitates or phase separates above the LCST. An example of this is poly(N-isopropylacrylamide) (pNIAAm), which has an LCST of about 32° C. in water, that is, it is soluble in water below 32° C., but becomes insoluble above 32° C. Copolymers with pNIAAm also exhibit a LCST with hydrophilic monomers increasing the LCST and hydrophobic monomers decreasing the LCST. Non-limiting examples of hydrophobic monomers are methyl methacrylate, hexafluorobutylmethacrylate, hexylacrylate, hexafluoroisopropylmethacrylate. Other monomers that may be polymerized with pNIAAm are acrylic acid and butymethacrylate. Tri-block copolymers of poly(N-isopropylacrylamide) with blocks of a copolymer of 2-hydroxyethyl methacrylate) and (2-dimethyl amino)ethyl methacrylate on each side of the poly(N-isopropylacrylamide) block exhibit the same LCST as pNIPAAm.

Examples of other polymers exhibiting a LCST include PLURONIC® type block copolymers (trade name of BASF Corp.) of PEO-PPO-PEO (poly(ethylene oxide)-poly(propylene oxide)-poly(ethylene oxide)) that gel at 37° C. A particular PLURONIC® type block copolymers is F127 which has the general formula (ethylene oxide)₉₉-(propylene oxide)₆₇-(ethylene oxide)₉₉ where the subscripts refer to the number of constitutional units per block. Others include poly(N,N-dimethyl-aminomethacrylate), N-alkyl substituted aminoacrylamides, N-alkyl substituted aminoacrylates, N-alkyl substituted aminomethacylates, xyloglucan (a natural polymer), and the general category of compounds with an α-amino acid.

Another example of temperature dependency that can be exploited is exhibited by the amphiphilic copolymer gel formed from two monomers, acrylamidopropyl-sulfonic acid (AMPS) which is negatively charged, and meth-acrylamidopropyl-trimethyl-ammonium chloride (MAPTA) which is positively charged. The polymer exhibits discontinuous swelling at temp of ˜30° C. in 79 wt % ethanol/water. At lower temperatures the material is rubbery, and at higher temperatures the material is glassy and rigid, thus indicating a phase transition.

A change in ionic strength may also be used as a precipitation trigger. An example, without limitation, is a copolymer gel obtained from the copolymerization of N-isopropylacrylamide (NIPA) with sodium acrylate. An increase in salt concentration decreases the ability of the gel to swell even above its LCST, thus indicating a salting out or precipitation by increased salt concentration.

The precipitation trigger may also be a change in electrical field or a change in magnetic field. For a change in electrical field to result in precipitation or the formation of a coating, the coating materials need to contain charged or ionizable functional groups. For a change in magnetic field to have an effect, the polymer and/or the drug in the coating solution may be a paramagnetic or ferromagnetic species, and/or a paramagnetic or ferromagnetic species that may be included among the constituents of the coating solution.

The precipitation trigger may comprise use of a supercritical fluid, either alone or in combination with another solvent, as the coating solvent such that precipitation of materials dissolved in the coating solvent may be accomplished by a change in temperature and/or pressure. Supercritical fluids are particularly advantageous as a small change in temperature or pressure can result in a major change in solubility of substances in the fluid. That is, a small change, in some cases as little as 5%, in temperature and/or pressure may result in precipitation of a substance which was completely soluble prior to the change.

Another aspect of the present invention includes use of a fluid which is a gas at room temperature and pressure as the coating solvent. As a non-limiting example, liquid carbon dioxide may be used as a coating solvent for dip coating, a precipitation trigger may be applied to the system while the substrate is still in the liquid carbon dioxide and after precipitation of the substances in the coating solution has occurred the pressure/temperature can be adjusted such that the carbon dioxide volatilizes leaving the desired drug reservoir layer behind.

Of course, more common precipitation triggers such as addition of a non-solvent for one or more of the components of a coating solution may also be used. This approach can be effective in, without limitation, situations in which the drug is bound to the polymer and the combination is soluble in the coating solution solvent. Addition of a poor solvent for the polymer can cause precipitation of the polymer and along with it the bound drug. If the coating solution solvent is a supercritical fluid, the precipitation trigger may be introduction of another gas into the coating solution. A non-limiting example is the addition of nitrogen to supercritical carbon dioxide.

An aspect of this invention encompasses the use of multiple precipitation triggers. Examples include, without limitation, the polymer pNIPAAm, the solubility of which is impacted by pH changes as well as temperature changes; 4-acrylamidosalicylic acid that has been cross-linked with N,N′-methylenebisacrylamide exhibits two phase transition loops depending upon a combination of pH and temperature; the gel made from a copolymer of N-isopropyl-acrylamide (NIPA) and sodium acrylate swells or shrinks based upon a change in temperature and salt concentration; and coating materials with ionizable groups may be ionized by a change in pH followed by application of an electric field.

It is relatively rare that the same precipitation trigger will cause precipitation of both the polymer and the drug from a coating solution. This problem, however, can be overcome in a number of ways. For example, one means of incorporating a drug into a final drug reservoir layer of this invention is by physical entrapment of the drug by a precipitating polymer. Thus, the polymer may be dissolved in the coating solvent while the neat drug is dispersed as a nano- or micro-particle in the coating solvent. As the polymer precipitates out of solution, it can entrap the drug.

Another means of accomplishing the above is by embedding or encapsulating the drug in a carrier, such as, without limitation, a micelle, a liposome, a nanoparticle or a microparticle. The drug-containing micelles, liposomes, nano- or microparticles can then be entrapped or entrained by the precipitating polymer.

While, as mentioned above, rarely, under certain circumstances will it be possible to coprecipitate a drug and a polymer. In such cases, the drug reservoir layer formed can have the drug interdispersed with the polymer. If both the drug and the polymer are similarly ionized or charged, it is possible to precipitate the combination onto a substrate by the application of an electric field. If the drug itself is not ionized or charged, it can be incorporated in a micelle, liposome, nano- or micro-particle which is charged by the presence of one or more charged or ionizable groups on its surface and both the charged particles and the charged polymer can be deposited on a substrate when an electric field is applied.

Another method of incorporating the drug into a controlled release rate drug reservoir layer of this invention is by non-permanent binding of the drug to the polymer such that, after the coating having a predetermined microstructure has been deposited on the substrate, the drug can be separated from the polymer and released from the coating. A simple technique for accomplishing this, if the polymer and drug are amenable to such, which will be apparent to those skilled in the art, is by formation of hydrogen bonds between the drug and the polymer. Alternatively, the polymer may be modified to include a specific binding moiety. Examples of binding moieties include, without limitation, crown ethers, cyclodextrins, chelating agents, ligands, cryptands, and antibodies. When the precipitation trigger is applied the entire complex precipitates in a desired microstructure after which the drug may be released from the complex.

Surfactants may be incorporated in the coating solution to assist in the dispersion of the drug and/or the polymer in the coating solution.

If micro- or nano-particles are used, their surfaces may be functionalized in manners well-known in the art to prevent aggregation of the particles in the coating solvent.

Precipitation by a change in the ionic strength or pH may be accomplished by spraying a concentrated salt solution or a solution with the appropriate pH onto a substrate onto which the coating solution has already been applied but from which the solvent has not yet been removed. Preferably at present, to effect a change in pH or ionic strength, the concentrated salt solution can be added to a coating solution in which the substrate has been submerged since this approach is more likely to result in a uniform precipitation of the drug and polymer from the coating solution. Similarly, the addition of a non-solvent for at least one of the coating materials may be accomplished by spraying the non-solvent onto a substrate previously sprayed with a coating solution, or addition of the non-solvent to a coating solution in which the substrate is immersed. Once again, the latter approach is presently preferred in that it is likely to result in a more uniform precipitation.

A change in electric field may be accomplished by creating a voltage difference between the substrate surface and the bulk of the solution. If the substrate is metallic, deposition of anions onto its surface may be accomplished if it can act as an anode or, conversely, cationic species may be deposited on it if it can act as a cathode. Similarly, if the polymer contains paramagnetic regions and the drug is bound to the polymer, creation of a magnetic field at the surface of the substrate can attract the polymer to the surface.

A number of methods may be used to precipitate with a temperature change. If the substrate is submerged in the coating solution, the addition of a solution at a markedly different temperature may alter the temperature sufficiently to precipitate the coating materials. Other means of heating or cooling the coating solution could also be used such as a heating jacket around the solution or heating coils in the solution. In some aspects heating with an infrared lamp may be used. An aqueous solution may be subjected to microwave radiation to effect rapid heating. It is preferable that the temperature change be abrupt. This can be most readily achieved by instituting a local temperature change at the surface of the substrate. For conductive substances such as metals this can easily be accomplished by direct rapid heating or cooling of the of the substrate. Heating of a metallic implant can be accomplished by resistive heating with an electric current or by subjecting the part to radio frequency for inductive heating. Even with relatively non-conductive materials such as some polymers, if the heating or cooling applied to its surface is sufficiently intense, rapid local changes in temperature at the substrate-coating solution interface can be achieved.

In another aspect of the invention, a coating layer may be deposited by alternatively applying a polyanion and then a polycation solution to the surface or vice versa. Initially the substrate is appropriately charged, that is, it should carry a positive charge if a polyanion solution is to be applied first, and a negative charge if a polycation solution is to be applied first. The substrate can then be dipped in the appropriate solutions, alternating between anionic and cationic solutions. Another method would be to alternate spraying the polyanion and polycation solutions onto the substrate. The process may be continued until a selected drug reservoir layer thickness is obtained.

It is of course desirable to avoid precipitation of the drug and/or the polymer onto surfaces other that the intended substrate when dip coating is used. One method of accomplishing this is to use coating containers made of a material with a low surface energy. Smooth surfaces of a low surface energy material such as poly(tetrafluoroethylene) for organics or more polar surfaces such as cellulose acetate for aqueous solution will tend to nucleate precipitation less on the container surfaces. It likewise is desirable to avoid precipitation in the bulk of the coating solution rather than on the substrate. If the drug and the polymer are both soluble in the coating solution, this can be accomplished by filtering the coating solution to remove nucleation sites. Of course, this method of avoiding bulk precipitation may not be applicable to those embodiments in which one or more of the coating materials is dispersed as opposed to dissolved in the coating solvent.

Another method to avoid bulk precipitation is to perform the coating application from a two-phase solvent system comprising two solvents, one having a lower density than the other. If the solvent system is placed in a cylindrical container and the container is placed on its side and rapidly spun, the lower density solvent will accumulate along the axis of rotation and will not be in contact with the walls of the container. If the substrate is located in the lower density phase and the precipitation trigger is applied, the precipitating substances will have nowhere to go but to adhere to the substrate.

In some aspects, precipitation in bulk may if fact be desirable and the precipitated materials may be deposited onto the substrate by accretion. A constant mixing of the solution as precipitation and accretion occur can result in a substantially uniform deposition of the materials onto the substrate. Impingement of the precipitate onto the substrate can be facilitated by stirring.

Pre-treatment of the substrate surface may also be used to ensure that coating materials are deposited on the substrate and not on other surfaces. If the coating materials are charged, such as in the case of polyanions and polycations, an oppositely charged substrate surface can attract the coating material to the surface. Other methods of pre-treating the surface of the substrate include, without limitation, plasma treatment, oxidation of the substrate surface, ion implantation, chemical vapor deposition and electrolytic deposition. In an aspect of the invention, pretreatment involves application of a layer of calcium, or other alkali metal, onto the substrate surface, which results in the creation of a charged surface. One method of applying a calcium layer is by dipping the substrate into molten calcium, removing it and allowing the calcium to cool and solidify. Another method is electroplating out of an alkali metal in an non-aqueous electrolyte. In another aspect of the invention, ion implantation with alkali metal cations such as sodium, potassium, calcium or magnesium is performed to create a surface with a net cationic charge.

In the various aspects of the invention, once the precipitation has been triggered, and the coating materials have been deposited onto the substrate, the coating solvent is removed. The coating solvent may be removed under ambient conditions if the solvent is sufficiently volatile such as may be the case if dip coating is used, by heating the substrate, by placing the substrate in a flow of unheated or heated air or other gas or fluid, or alternatively by freeze drying. If the coating solution includes a supercritical or near supercritical fluid, a change in pressure and temperature may simultaneously deposit the coating materials onto the substrate as well as vaporize the solvent. A solvent may also be removed by contacting the coated substrate surface with a supercritical fluid.

Optionally, the polymer may be cross-linked after the precipitation trigger has been applied and the coating materials have been deposited onto the substrate. To accomplish this, a cross-linking agent may be added to the coating solution, and co-precipitated with the other coating materials. Any type of cross-linking known in the art and that is compatible with the drug, i.e., does not adversely affect it, may be used. In some embodiments, cross-linking of the polymer is initiated prior to solvent removal, while in other embodiments, cross-linking is conducted after solvent removal.

A presently preferred substrate for application of the method herein is a stent. Other possible substrates include nanoparticles or microparticles. The nanoparticles or microparticles may be used “as is,” that is, they may be delivered directly to a treatment site by implantation or targeted delivery. Or they may be incorporated into another device such as a stent.

Aspects of the present invention encompass coating layers that may cover all, or only a portion of, the surface of a substrate that is in contact with bodily tissues or fluids. As a non-limiting example, if the substrate is a stent, an abluminal surface may be selectively coated, or a luminal surface may be selectively coated.

The individual layers of a multilayer drug reservoir layer of this invention can independently be of any thickness that will result in the desired release rate and an appropriate overall drug reservoir layer thickness. For example, each layer can have a thickness of about 30 microns, about 20 microns, about 10 microns, about 5 microns, about 3 microns or any other desirable thickness.

The coating materials that may be used in the various embodiments of the present invention include inorganic materials, polymers including hydrophobic polymers and biopolymers, and metals by electroless deposition.

Polymers used in the coating solutions may be synthetic, semi-synthetic, natural, hydrophobic and/or hydrophilic. The polymers may be in a molecular weight range, expressed as the weight-average-molecular weight, from 1,000 to 5 million Daltons (Da), preferably at present 10,000 to 1 million Da, and more preferably at present from 20,000 to 500,000 Da.

Representative examples of polyions include poly(aspartic acid), poly(glutamic acid), heparin sulfate, chondroitin sulfate, poly(lysine), poly(arginine), poly(histidine), sialic acid, alginate, gelatin, collagen, poly(orthophosphate), poly(acrylic acid), poly(methacrylic acid), poly(phosphoesters), poly(allyl amine), poly(ethyleneimine), poly(dimethylaminoethylmethacrylate) (pDMEAM), poly(diethylamino-ethylmethacrylate) (pDEAEM), poly(acrylol-L-proline ethyl ester), poly(methyacrylolglycine), poly(methacrylic acid-glycine), poly(methacrylic acid-co-nitrophenylacrylate), acrylic acid copolymers, methacrylic acid copolymers, and blends of polyacrylic acids.

Representative hydrophobic polymers include, but are not limited to, poly(ester amide), polystyrene-polyisobutylene-polystyrene block copolymer (SIS), polystyrene, polyisobutylene, polycaprolactone (PCL), poly(L-lactide), poly(D,L-lactide), poly(lactides), polylactic acid (PLA), poly(lactide-co-glycolide), poly(glycolide), polyalkylenes, polyfluoroalkylenes, polyhydroxyalkanoates, poly(3-hydroxybutyrate), poly(4-hydroxybutyrate), poly(3-hydroxyvalerate), poly(3-hydroxybutyrate-co-3-hydroxyvalerate), poly(3-hydroxyhexanoate), poly(4-hyroxyhexanoate), mid-chain polyhydroxyalkanoates, poly(trimethylene carbonate), poly(ortho ester), polyphosphazenes, poly(phosphoesters), poly(tyrosine derived arylates), poly(tyrosine derived carbonates), polydimethylsiloxane (PDMS), polyvinylidene fluoride (PVDF), polyhexafluoropropylene (HFP), polydimethylsiloxane, poly(vinylidene fluoride-co-hexafluoropropylene) (PVDF-HFP), poly(vinylidene fluoride-co-chloro-trifluoroethylene) (PVDF-CTFE), poly(vinylidene chloride), poly(vinylidene chloride-co-hexafluoropropylene), poly(methacrylates) such as poly(butyl methacrylate) (PBMA) or poly(methyl methacrylate) (PMMA), poly(vinyl acetate), poly(ethylene-co-vinyl acetate), poly(ethylene-co-vinyl alcohol), poly(ester urethanes), poly(ether-urethanes), poly(carbonate-urethanes), poly(silicone-urethanes), poly(urea-urethanes) and any combination thereof.

Other representative biocompatible polymers include, but are not limited to, polyhydroxyalkanoates (PHA), poly(3-hydroxyalkanoates) such as poly(3-hydroxypropanoate), poly(3-hydroxyheptanoate) and poly(3-hydroxy-octanoate), poly(4-hydroxyalkanaote) such as poly(4-hydroxyheptanoate), poly(4-hydroxyoctanoate) and copolymers including any of the 3-hydroxy-alkanoate or 4-hydroxyalkanoate monomers described herein, poly(lactide-co-caprolactone), poly(glycolide-co-caprolactone), polymers and copolymers of any combination of the group consisting of D-lactic acid, L-lactic acid, D,L lactic acid, glycolic acid, and caprolactone, poly(dioxanone), poly(anhydrides), poly(tyrosine ester) and derivatives thereof, poly(imino carbonates), poly(glycolic acid-co-trimethylene carbonate), polyphosphoester urethane, poly(amino acids), polycyanoacrylates, poly(iminocarbonate), silicones, polyesters, polyolefins, polyisobutylene and ethylene-alphaolefin copolymers, acrylic polymers and copolymers, vinyl halide polymers and copolymers such as polyvinyl chloride, polyvinyl ethers such as polyvinyl methyl ether, polyvinylidene halides such as polyvinylidene chloride, polyacrylonitrile, polyvinyl ketones, polyvinyl aromatics such as polystyrene, polyvinyl esters, copolymers of vinyl monomers with each other and olefins such as ethylene-methyl methacrylate copolymers, acrylonitrile-styrene copolymers, ABS resins, polyamides such as, without limitation Nylon 66 and polycaprolactam, alkyd resins, polycarbonates, polyoxymethylenes, polyimides, polyethers, poly(glyceryl sebacate), poly(propylene fumarate), poly(n-butyl methacrylate), poly(sec-butyl methacrylate), poly(isobutyl methacrylate), poly(tert-butyl methacrylate), poly(n-propyl methacrylate), poly(isopropyl methacrylate), poly(ethyl methacrylate), other methacrylates and acrylates (polymers and copolymers), epoxy resins, polyurethanes, rayon, rayon-triacetate, cellulose acetate, cellulose butyrate, cellulose acetate butyrate, cellophane, cellulose nitrate, cellulose propionate, cellulose ethers, carboxymethyl cellulose, other cellulose derivatives, poly(ethylene glycol) (PEG), copoly(ether-esters) (e.g. poly(ethylene oxide/poly(lactic acid) (PEO/PLA)), polyalkylene oxides such as poly(ethylene oxide) and poly(propylene oxide), poly(ether ester), polyalkylene oxalates, polyphosphazenes, polymers containing methacryloyl phosphoryl choline, poly(aspirin), polymers and co-polymers of hydroxyl bearing monomer such as 2-hydroxyethyl methacrylate (HEMA), hydroxypropyl methacrylate (HPMA), hydroxypropylmethacrylamide, PEG acrylate (PEGA), PEG methacrylate, 2-methacryloyloxyethylphosphorylcholine (MPC) and n-vinyl pyrrolidone (VP), poly(vinyl pyrrolidone), carboxylic acid bearing monomer such as methacrylic acid (MA), acrylic acid (AA), alkoxymethacrylate, alkoxyacrylate, and 3-trimethylsilylpropyl methacrylate (TMSPMA), poly(styrene-isoprene-styrene)-PEG (S IS-PEG), polystyrene-PEG, polyisobutylene-PEG, polycaprolactone-PEG (PCL-PEG), PLA-PEG, poly(methyl methacrylate)-PEG (PM MA-PEG), polydimethylsiloxane-co-PEG (PDMS-PEG), poly(vinylidene fluoride)-PEG (PVDF-PEG), PLURONIC™ surfactants (polypropylene oxide-co-polyethylene glycol block co-polymers), poly(tetramethylene glycol), hydroxy functional poly(vinyl pyrrolidone), biomolecules such as chitosan, alginate, fibrin, fibrinogen, cellulose, starch, dextran, dextrin, fragments and derivatives of hyaluronic acid, polysaccharide, chitosan, alginate, or any blends or combinations thereof.

As used herein, the terms poly(D,L-lactide), poly(L-lactide), poly(D,L-lactide-co-glycolide), and poly(L-lactide-co-glycolide) can be used interchangeably with the terms poly(D,L-lactic acid), poly(L-lactic acid), poly(D,L-lactic acid-co-glycolic acid), or poly(L-lactic acid-co-glycolic acid).

Representative drugs include, but are not limited to, synthetic inorganic and organic compounds, proteins and peptides, polysaccharides and other sugars, lipids, and DNA and RNA nucleic acid sequences having therapeutic, prophylactic or diagnostic activities. Nucleic acid sequences include genes, antisense molecules that bind to complementary DNA to inhibit transcription, and ribozymes. Some other examples of other drugs include antibodies, receptor ligands such as the nuclear receptor ligands estradiol and the retinoids, enzymes, adhesion peptides, blood clotting factors, inhibitors or clot dissolving drugs such as streptokinase and tissue plasminogen activator, antigens for immunization, hormones and growth factors, oligonucleotides such as antisense oligonucleotides, ribozymes and retroviral vectors for use in gene therapy, and genetically engineered endothelial cells. Other drugs include heparin, fragments and derivatives of heparin, glycosamino glycan (GAG), GAG derivatives, alpha-interferon, and thiazolidinediones (glitazones). The drugs could be designed, e.g., to inhibit the activity of vascular smooth muscle cells. They could be directed at inhibiting abnormal or inappropriate migration and/or proliferation of smooth muscle cells to inhibit restenosis.

Examples of drugs that may be suitable for use in the various embodiments of the present invention, depending, of course, on the specific disease being treated, include, without limitation, anti-restenosis, pro- or anti-proliferative, anti-inflammatory, anti-neoplastic, antimitotic, anti-platelet, anticoagulant, antifibrin, antithrombin, cytostatic, antibiotic, anti-enzymatic, anti-metabolic, angiogenic, cytoprotective, angiotensin converting enzyme (ACE) inhibiting, angiotensin II receptor antagonizing and/or cardioprotective drugs.

An antiproliferative drug can be a natural proteineous substance such as a cytotoxin or a synthetic molecule. Examples of antiproliferative substances include, but are not limited to, actinomycin D or derivatives and analogs thereof (manufactured by Sigma-Aldrich, or COSMEGEN available from Merck) (synonyms of actinomycin D include dactinomycin, actinomycin IV, actinomycin I₁, actinomycin X₁, and actinomycin C₁); all taxoids such as taxols, docetaxel, and paclitaxel and derivatives thereof; the macrolide antibiotic rapamycin (sirolimus) and its derivatives including without limitation, Biolimus A9 (Biosensors International, Singapore), deforolimus, AP23572 (Ariad Pharmaceuticals), tacrolimus, temsirolimus, pimecrolimus, novolimus, zotarolimus (ABT-578), 40-O-(2-hydroxy)ethyl-rapamycin (everolimus), 40-O-(3-hydroxypropyl)rapamycin, 40-O-[2-(2-hydroxy)ethoxy]ethyl-rapamycin, 40-O-tetrazolylrapamycin, 40-epi-(N1-tetrazolyl)-rapamycin, and the functional or structural derivatives of everolimus; all olimus drugs; FKBP-12 mediated mTOR inhibitors, prodrugs thereof, co-drugs thereof, and combinations thereof.

Additional examples of cytostatic or antiproliferative drugs include, without limitation, angiopeptin, and fibroblast growth factor (FGF) antagonists.

Examples of anti-inflammatory drugs include both steroidal and non-steroidal (NSAID) anti-inflammatories such as, without limitation, clobetasol, alclofenac, alclometasone dipropionate, algestone acetonide, alpha amylase, amcinafal, amcinafide, amfenac sodium, amiprilose hydrochloride, anakinra, anirolac, anitrazafen, apazone, balsalazide disodium, bendazac, benoxaprofen, benzydamine hydrochloride, bromelains, broperamole, budesonide, carprofen, cicloprofen, cintazone, cliprofen, clobetasol propionate, clobetasone butyrate, clopirac, cloticasone propionate, cormethasone acetate, cortodoxone, deflazacort, desonide, desoximetasone, dexamethasone, dexamethasone dipropionate, dexamethasone acetate, dexmethasone phosphate, momentasone, cortisone, cortisone acetate, hydrocortisone, prednisone, prednisone acetate, betamethasone, betamethasone acetate, diclofenac potassium, diclofenac sodium, diflorasone diacetate, diflumidone sodium, diflunisal, difluprednate, diftalone, dimethyl sulfoxide, drocinonide, endrysone, enlimomab, enolicam sodium, epirizole, etodolac, etofenamate, felbinac, fenamole, fenbufen, fenclofenac, fenclorac, fendosal, fenpipalone, fentiazac, flazalone, fluazacort, flufenamic acid, flumizole, flunisolide acetate, flunixin, flunixin meglumine, fluocortin butyl, fluorometholone acetate, fluquazone, flurbiprofen, fluretofen, fluticasone propionate, furaprofen, furobufen, halcinonide, halobetasol propionate, halopredone acetate, ibufenac, ibuprofen, ibuprofen aluminum, ibuprofen piconol, ilonidap, indomethacin, indomethacin sodium, indoprofen, indoxole, intrazole, isoflupredone acetate, isoxepac, isoxicam, ketoprofen, lofemizole hydrochloride, lomoxicam, loteprednol etabonate, meclofenamate sodium, meclofenamic acid, meclorisone dibutyrate, mefenamic acid, mesalamine, meseclazone, methylprednisolone suleptanate, morniflumate, nabumetone, naproxen, naproxen sodium, naproxol, nimazone, olsalazine sodium, orgotein, orpanoxin, oxaprozin, oxyphenbutazone, paranyline hydrochloride, pentosan polysulfate sodium, phenbutazone sodium glycerate, pirfenidone, piroxicam, piroxicam cinnamate, piroxicam olamine, pirprofen, prednazate, prifelone, prodolic acid, proquazone, proxazole, proxazole citrate, rimexolone, romazarit, salcolex, salnacedin, salsalate, sanguinarium chloride, seclazone, sermetacin, sudoxicam, sulindac, suprofen, talmetacin, talniflumate, talosalate, tebufelone, tenidap, tenidap sodium, tenoxicam, tesicam, tesimide, tetrydamine, tiopinac, tixocortol pivalate, tolmetin, tolmetin sodium, triclonide, triflumidate, zidometacin, zomepirac sodium, aspirin (acetylsalicylic acid), salicylic acid, corticosteroids, glucocorticoids, tacrolimus and pimecrolimus.

Alternatively, the anti-inflammatory drug can be a biological inhibitor of pro-inflammatory signaling molecules. Anti-inflammatory biological drugs include antibodies to such biological inflammatory signaling molecules.

Examples of antineoplastics and antimitotics include, without limitation, paclitaxel, docetaxel, methotrexate, azathioprine, vincristine, vinblastine, fluorouracil, doxorubicin hydrochloride and mitomycin.

Examples of anti-platelet, anticoagulant, antifibrin, and antithrombin drugs include, without limitation, heparin, sodium heparin, low molecular weight heparins, heparinoids, hirudin, argatroban, forskolin, vapiprost, prostacyclin, prostacyclin dextran, D-phe-pro-arg-chloromethylketone, dipyridamole, glycoprotein IIb/IIIa platelet membrane receptor antagonist antibody, recombinant hirudin and thrombin, thrombin inhibitors such as ANGIOMAX® (bivalirudin), calcium channel blockers such as nifedipine, colchicine, fish oil (omega 3-fatty acid), histamine antagonists, lovastatin, monoclonal antibodies such as those specific for Platelet-Derived Growth Factor (PDGF) receptors, nitroprusside, phosphodiesterase inhibitors, prostaglandin inhibitors, suramin, serotonin blockers, steroids, thioprotease inhibitors, triazolopyrimidine, nitric oxide or nitric oxide donors, super oxide dismutases, super oxide dismutase mimetic and 4-amino-2,2,6,6-tetramethylpiperidine-1-oxyl (4-amino-TEMPO).

Examples of ACE inhibitors include, without limitation, quinapril, perindopril, ramipril, captopril, benazepril, trandolapril, fosinopril, lisinopril, moexipril and enalapril.

Examples of angiogensin II receptor antagonists include, without limitation, irbesartan and losartan.

Other drugs include antivirals; analgesics and analgesic combinations; anti-anorexics; antihelmintics; antiarthritics, antiasthmatic drugs; anticonvulsants; antidepressants; antidiuretic drugs; antidiarrhetics; antihistamines; antimigrain preparations; antinauseants; antiparkinsonism drugs; antipruritics; antipsychotics; antipyretics; antispasmodics; anticholinergics; sympathomimetics; xanthine derivatives; cardiovascular preparations including calcium channel blockers and beta-blockers such as pindolol and antiarrhythmics; antihypertensives; diuretics; vasodilators including general coronary vasodilators; peripheral and cerebral vasodilators; central nervous system stimulants; cough and cold preparations, including decongestants; hypnotics; immunosuppressives; muscle relaxants; parasympatholytics; psychostimulants; sedatives; tranquilizers; naturally derived or genetically engineered lipoproteins; and restenoic reducing drugs.

### EXAMPLES

The examples presented in this section are provided by way of illustration of the current invention only and are not intended nor are they to be construed as limiting the scope of this invention in any manner whatsoever. Each of the examples the follows relates to the coating of 3×12 mm VISION™ (Abbott Cardiovascular Systems Inc.) stent, which has a coatable surface area of 0.5556 cm².

### Example 1

Microparticles are made of sirolimus via an oil in water emulsification method using poly(vinyl alcohol) or human serum albumin as a stabilizer. Briefly, the drug is dissolved in methylene chloride and this solution is dispersed via ultrasonication or by rotor-stator homogenizer in an aqueous solution of the stabilizer. After formation, the solution is stirred to allow the methylene chloride to evaporate and the particles harvested by centrifugation. To an aqueous solution in a beaker equipped with a controlled temperature jacket and magnetic stir bar is added poly(N-isopropyl acrylamide) (pNIPA) and sirolimus particles at ambient temperature. VISION stents are immersed in this bath and with stirring, the temperature is raised to 37° C. After the pNIPA and drug has precipitated onto the stents, the stents are removed and either air dried or lyophilized.

### Example 2

Microparticles of zotarolimus are produced in a manner analogous to the microparticles in Example 1. To a Teflon beaker equipped with magnetic sir bar is added an aqueous solution of sodium alginate at pH 6. Zotarolimus particles are added and 3×12 mm VISION stents are immersed in the solution. With stirring, HCl is added to lower the pH to 3.0 where the alginate and drug particles precipitate onto the stents. The solution pH is then raised by addition of aqueous calcium hydroxide to pH 7. Calcium crosslinks and hardens the alginate layer. After the removal of the stents, any remaining water is removed by air drying or lyophilization.

### Example 3

Microparticles of dexamethasone acetate are produced in a manner analogous to the process used in Example 1. To a Teflon beaker equipped with magnetic sir bar is added an aqueous solution of polyglutamic acid in a phosphate buffer at pH 6.5. VISION stents, 3×12 mm, are immersed in this bath and an aqueous solution of polylysine is slowly added. After the polyelectrolytes and drug have coacervated onto the stents, they are taken from the bath and any remaining water is removed by air drying or lyophilization.

### Example 4

In a beaker equipped with magnetic stirrer is placed a solution of everolimus and poly(vinylidene fluoride-co-hexafluoropropylene) which are dissolved in acetone. VISION 3×12 mm stents are immersed in this solution and water is slowly added with gentle stirring to bring about the precipitation of the polymer and drug onto the stents. After precipitation, the stents are removed and the trace of remaining acetone is removed by air drying.

### Example 5

To a TEFLON™ beaker equipped with magnetic stirrer is added an aqueous solution of poly(butyl methacrylate-co-methacrylic acid) and zotarolimus microparticles at pH 7. VISION stents, 3×12 mm, are immersed in the solution, and, with stirring, a saturated aqueous solution of sodium chloride is added. After all of the polymer has been salted out with entrapped drug microparticles, the stents are removed and any remaining water is removed by air drying or lyophilization.

### Example 6

Sirolimus microparticles are produced as in Example 1. To a Teflon beaker equipped with magnetic stirrer is added an aqueous solution of sodium heparin and sirolimus microparticles at pH 7. VISION stents, 3×12 mm, are immersed and, with stirring, a THF solution of tridodecylmethyl ammonium chloride is added. After all of the heparin (now hydrophobic) with entrapped drug microparticles is precipitated, the stents are removed and any remaining water is removed by air drying or lyophilization.

What is claimed:

1. A method of applying a coating to a substrate, comprising:
dissolving or dispersing a polymer in a solvent;
dissolving or dispersing a drug in the solvent to form a coating solution;
disposing the coating solution over at least a portion of a surface of a substrate;
precipitating both the polymer and the drug onto the surface of the substrate; and,
after precipitation, substantially removing the solvent.

2. The method of claim 1, wherein the substrate is selected from the group consisting of an implantable medical device and a particle.

3. The method of claim 2, wherein the implantable medical device is a stent.

4. The method of claim 1, wherein the polymer comprises a biopolymer.

5. The method of claim 1, wherein the polymer comprises a hydrophobic polymer.

6. The method of claim 2, wherein the particle is selected from the group consisting of a micelle, liposome, a nanoparticle and a microparticle.

7. The method of claim 1, wherein the polymer comprises a binding moiety.

8. The method of claim 7, wherein the binding moiety is selected from the group consisting of a cyclodextrin, a crown ether, a chelating agent, a ligand, a cryptand, an antibody and any combination thereof.

9. The method of claim 1, wherein precipitation is initiated by a precipitation trigger.

10. The method of claim 9, wherein the precipitation trigger is selected from the group consisting of a change in pH, a change in temperature, a change in pressure, addition of specific ions, a change in dielectric potential, a change in ionic strength, a change in light wavelength and/or intensity, addition of a non-solvent, a change in electric potential, a change in magnetic field strength, and combinations thereof.

11. The method of claim 10, wherein the precipitation trigger comprises a change in temperature of the substrate.

12. The method of claim 1, wherein the solvent is a supercritical fluid.

13. A method of applying a coating to a substrate, the method comprising:
dissolving or dispersing a polycation in a first solvent;
dissolving or dispersing a first drug in the first solvent to create a polycation coating solution;
disposing the polycation coating solution over at least a portion of a surface of a substrate wherein the substrate is negatively charged;
substantially removing the solvent;
dissolving or dispersing a polyanion in a second solvent, which may be the same as or different from the first solvent;
dissolving or dispersing a second drug, which may be the same as or different from the first drug, in the second solvent to form a polyanion coating solution;
disposing the polyanion coating solution over at least the portion of the surface of the substrate over which the polycation coating solution has been disposed;
substantially removing the solvent;
alternating disposing of the polycation coating solution, substantially removing the solvent, disposing the polyanion coating solution and substantially removing the solvent, until a desired drug reservoir thickness is achieved.

14. The method of claim 13, wherein disposing the polyanion and polycation solutions comprises spraying the solutions onto the substrate.

15. The method of claim 13, wherein disposing the polyanion and polycation solutions comprises dipping the substrate in the solutions.

16. A method of applying a coating to a substrate, the method comprising:
dissolving or dispersing a polyanion in a first solvent;
dissolving or dispersing a first drug in the first solvent to form a polyanion coating solution;
disposing the polyanion coating solution to at least a portion of a surface of a substrate wherein the substrate is positively charged;
substantially removing the solvent;
dissolving or dispersing a polycation in a second solvent;
dissolving or dispersing a second drug, which may be the same as or different from the first drug, in the second solvent to create a polycation coating solution;
disposing the polycation coating solution over the portion of the surface of the substrate over which the polyanion coating solution has been disposed;
substantially removing the solvent;
alternating disposing the polyanion coating solution, substantially removing the solvent, disposing the polycation solution and substantially removing the solvent until a desired coating thickness is achieved.

17. The method of claim 16, wherein disposing the polyanion and polycation solutions comprises spraying the solutions onto the substrate.

18. The method of claim 16, wherein disposing the polyanion and polycation solutions comprises dipping the substrate into the solutions.
